(19) United States
(12) Patent Application Publication
(10) Pub. No.: US 2002/0044982 A1
(43) Pub. Date: Apr. 18, 2002

(54) Distribution unit for dry forming of web material

(75) Inventors: Paavo Hyvarinen, Kotka (FI); Heikki Niranen, Hameenlinna (FI)

Correspondence Address: DARBY & DARBY P.C., 805 Third Avenue, New York, NY, 10022, US

(73) Assignee: BKI Holding Corporation, Wilmington, DE (US)

(21) Appl. No.: 09/977,916

(22) Filed: Oct. 8, 2001

Related U.S. Application Data
(63) Continuation of application No. PCT/US00/09690, filed on Apr. 7, 2000.

(30) Foreign Application Priority Data
Apr. 9, 1999 (FI) 990784

(51) Int. Cl. B28B 5/00

(52) U.S. Cl. 425/83.1

(57) ABSTRACT

The invention relates to a distribution unit to be used in dry forming of web material, the distribution unit comprising one or more screen pipes (1) into which a fiber material (3) intended for forming a web is blown, the fibers penetrating through jackets (2) of the screen pipes in order to be layered onto a wire, and the screen pipe(s) (1) being arranged to extend transversely over the wire; and a rotatable brush roller (4) arranged inside each screen pipe (1) in the axial direction thereof. In the invention, a blade wheel (5) is provided inside each screen pipe (1) near the end that is opposite to the end where the fiber material (3) is blown into the pipe, the blade wheel being arranged to blow in a direction opposite to the direction of flow (A) of the fiber material.

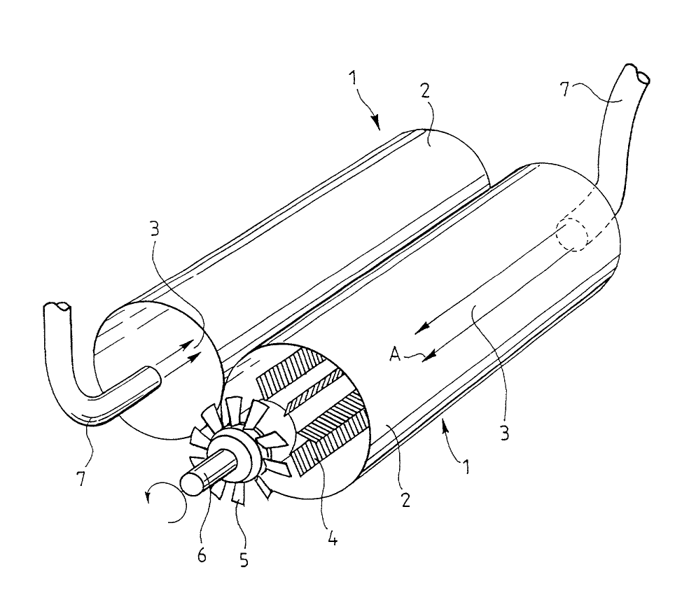

### FIELD OF THE INVENTION

The present invention relates to an improved distribution unit to be used in dry forming of web material, the distribution unit including one or more screen pipes into which a fibre material intended for forming a web is blown, the fibres penetrating through jackets of the screen pipes in order to be layered onto a wire, and the screen pipe(s) being arranged to extend transversely over the wire; and a rotatable brush roller arranged inside each screen pipe in the axial direction thereof. More particularly, the present invention relates to a distribution unit providing improved distribution of fibre by altering the airflow within the screen pipe.

### BACKGROUND OF THE INVENTION

Distribution units are known from Finnish Patent 66,948 and U.S. Pat. No. 4,352,649, hereby incorporated by reference. The Finnish patent describes the basic structure of a distribution unit typically applied in dry forming of sheet material. The distribution unit, generally called a former, includes screen pipes as described above placed preferably in pairs in order to make a fibre flow travel in opposite directions over the wire in the cross direction thereof. The primary reason for such positioning of the pipes is that in practice it is virtually impossible to make a fibre flow blown only in one direction over the wire to be deposited evenly onto the wire in the cross direction thereof so as to provide an even cross direction profile of a web to be produced. When screen pipes are placed in pairs so that the fibre flows in the pipes in opposite directions, a web's cross direction profile can be made considerably more even. In order for a web to be of uniform quality, the variation in the web thickness in the cross direction thereof should be minimal. An acceptable deviation from a target thickness is typically ±5%.

It has proved to be difficult to provide an even cross direction profile of the aforementioned standard level with the distribution unit of Finnish Patent 66,948, despite the use of screen pipes typically in pairs for the reasons described above. However, the basic structure of the distribution unit per se is useful and provides a high fibre discharge rate also with rather long fibres.

### SUMMARY OF THE INVENTION

In accordance with what is disclosed above, an object of the invention is to provide a distribution unit which is to be used in dry forming of web material and which facilitates formation of a more even cross direction profile of the web. This is achieved with a distribution unit according to the invention, which is characterized in that it further includes a blade wheel provided inside each screen pipe near the end that is opposite to the end where the fibre material is blown into the pipe, the blade wheel being arranged to blow in a direction opposite to the direction of flow of the fibre material.

A basic idea of the invention is that the flow of fibres inside a screen pipe is slowed down by a flow that is opposite to the fibre flow. This produces a more even cross direction profile, apparently particularly since more fibre material than previously can thus be layered onto the margin of the web where the blade wheel is located. When such screen pipes are placed in pairs so as to provide opposite flow directions for the fibre material in the pipes, more fibres than previously can also be made to accumulate onto the other margin of the web, which results in a more even total profile of the web. Previously, a typical web profile comprised less fibres on the margins than in the middle of the web.

The blade wheel is most preferably arranged on the shaft of the brush roller to rotate together with the roller. The blade wheel can also be fastened to a shaft, which is separate from the shaft of the brush roller and is rotatable with respect to the end surface of the screen pipe. This separate shaft is provided with an actuator arranged to rotate the shaft. In this manner the speed of rotation of the blade wheel can be adjusted independently of the rotational velocity of the brush roller. The speed of rotation of the brush roller is typically adjustable, but if a blade wheel provided in the roller rotates together with the roller, the structure of the blade wheel essentially determines the kind of reverse flow it produces. Particularly in view of such a structure where the blade wheel is arranged on the shaft of the brush roller to revolve therewith, the blade wheel could be provided with adjustable blades so that the flow it produces could be adjusted at least to some extent independently of the speed of rotation of the brush roller. On the other hand, it might be useful to provide the blade wheel with adjustable blades even if the shaft of the blade wheel were separate and provided with an actuator of its own.

As a result, it is preferable, although not necessary, that the screen pipes are arranged in the distribution unit in pairs so that the fibre material flows in opposite directions in screen pipes forming a pair.

### BRIEF DESCRIPTION OF THE DRAWINGS

In the following, a distribution unit according to the invention will be described in more detail with reference to the accompanying drawing, which shows schematically the main components of the distribution unit according to the invention.

### DETAILED DESCRIPTION OF THE INVENTION

The FIGURE shows the basic structure of the distribution unit according to the invention. It shows two screen pipes 1 arranged to extend transversely across a wire (not shown in the FIGURE). In the embodiment shown in the FIGURE, the screen pipes 1 are arranged in a pair so that the fibre material in the pipes flows in opposite directions of flow A. This is achieved by blowing a fibre material flow 3 into the pipes via feed pipes 7 arranged at opposite ends of the screen pipes. The feed pipes direct substantially axial flows of fibre material in an air-fluidized state into the screen pipes. Screen jackets 2 of the screen pipes 1 are arranged rotatably around their axes in a manner known per se.

The screen pipes also include brush rollers 4 arranged inside the pipes in a conventional manner also disclosed in Finnish Patent 66,948. The purpose of the brush rollers is to clean the jacket surfaces 2 of the screen pipes 1 and to improve the penetration of fibres through the jackets 2. The structure of the brush rollers is conventional and known for example from the aforementioned Finnish Patent.

In the invention, a blade wheel 5 is arranged inside the screen pipe 1 at the end opposite to the end where the fibres are input. The purpose of the blade wheel is to slow down the fibre flow 3 inside the screen pipe 1. A slower flow of fibres especially at the end of the screen pipe having the blade wheel enables fibres to be discharged through the jackets more evenly than previously along the entire length of the screen. This positive effect is most visible at the end of the screen pipe having the blade wheel. When the screen pipes are arranged in pairs as described in the illustrative embodiment shown in the drawing, so that the fibre material flows in opposite directions inside the pipes, the blade wheel provided in the other screen pipe slows down the flow and enables fibre material to be layered also onto the other margin of the web material to be formed. This provides a more even cross direction profile of the web than previously along the entire width thereof.

In the embodiment shown in the FIGURE, the blade wheel is arranged on the shaft 6 of the brush roller 4. In practice this provides a simple and advantageous structure. However, in such a case the dimensions of the blade wheel and the orientation of the blades must be accurately set already when the brush roller and the blade wheel are being installed in order to achieve the desired effect. It is possible that in the case of different types of fibre material the air flow produced by the blade wheel should also be different to provide the desired effect. At least in some cases this can be achieved by rotating the brush roller 4 at a suitable rate. Typically, this is possible due to the commonly used stepless speed regulation of brush rollers.

In another embodiment, it is naturally also possible to support the blade wheel on a shaft rotatable with respect to the end surface of the screen pipe 1. By providing this drive shaft of the blade wheel with a suitable actuator the blade wheel can be rotated at exactly a desired rate regardless of the rate of rotation of the brush roller. Even though such a structure is more complicated than the one described above where the blade wheel is arranged on the shaft of the brush roller, in practice it makes it far easier to adjust the strength of the reverse flow produced by the blade wheel. Such adjustment may be needed for example, in special cases where the properties of the fibre material vary greatly in the manufacture of different products.

Adjustment alternatives can be further improved by providing the blade wheel 5 with adjustable blades. The airflow volume and pressure created by the blade wheel can be adjusted by varying the orientation of the blades even without changing the rate of rotation of the blade wheel. Such a blade wheel provided with adjustable blades would be particularly useful when arranged on the shaft of the brush roller to rotate with it. In such a case the blades of the wheel could be set specifically for each type of fibre material, for example, when the material is changed. However, it is also possible to adjust the blades of the wheel when the distribution unit is in operation. Another possible alternative is to provide a blade wheel having a separate shaft. An actuator and adjustable blades to further increase the number of adjustment alternatives.

In a further embodiment, an alternate source of airflow may be provided. For example, compressed air generated remotely, may be provided via an air hose, to direct an airflow counter to fibre flow 3. The volume and pressure of the airflow may be adjusted as necessary, depending upon the source of compressed air.

The distribution unit according to the invention is described above by means of only one illustrative embodiment. It should therefore be understood that it can be modified to some extent without deviating from the basic idea of the invention where a fibre flow inside a screen pipe is slowed down by means of blowing that is opposite in direction to the fibre flow. In other respects, the structure of the screen pipe and the components thereof, such as the brush roller, can vary similarly as in the prior art distribution units.

1. A distribution unit to be used in dry forming of web material, the distribution unit comprising:
one or more screen pipes (1) into which a fibre material (3) intended for forming a web is blown, the fibres penetrating through jackets (2) of the screen pipes in order to be layered onto a wire, and the screen pipe(s) (1) being arranged to extend transversely over the wire;
a rotatable brush roller (4) arranged inside each screen pipe (1) in the axial direction thereof, and
a blade wheel (5) provided inside each screen pipe (1) opposite to the end where the fibre material (3) is blown into the pipe, the blade wheel being arranged to blow air in a direction opposite to the direction of flow (A) of the fibre material.

2. A distribution unit according to claim 1, wherein the blade wheel (5) is arranged on the shaft (6) of the brush roller (4).

3. A distribution unit according to claim 1, wherein the blade wheel is fastened to a shaft which is separate from the shaft of the brush roller, rotatable with respect to the end surface of the screen pipe and provided with an actuator for rotating it.

4. A distribution unit according to claim 1 and wherein the blade wheel (5) is provided with adjustable blades.

5. A distribution unit according to claim 1, wherein the screen pipes (1) are arranged in pairs so that the fibre material flows in opposite directions in screen pipes forming a pair.

6. A distribution unit to be used in dry forming of web material, the distribution unit comprising:
one or more screen pipes (1) into which a fibre material (3) intended for forming a web is blown, the fibres penetrating through jackets (2) of the screen pipes in order to be layered onto a wire, and the screen pipe(s) (1) being arranged to extend transversely over the wire;
a rotatable brush roller (4) arranged inside each screen pipe (1) in the axial direction thereof; and
means for supplying an airflow at each screen pipe (1) in a direction opposite to the direction that fibre material (3) is blown into the pipe.

7. A distribution unit according to claim 6, wherein said airflow supply means is a source of compressed air.
